(19) United States
(12) Patent Application Publication
(10) Pub. No.: US 2022/0072853 A1
(43) Pub. Date: Mar. 10, 2022

(54) A printing method for inkjet printers

(71) Applicants: Yuan CHANG, Beijing (CN); BEIJING MEIKEYI, CO., LTD., Beijing (CN)

(72) Inventor: Yuan Chang, Newtown Square, PA (US)

(21) Appl. No.: 17/417,755

(22) PCT Filed: Dec. 2, 2019
(86) PCT No.: PCT/CN2019/122325

§ 371 Date: Jun. 24, 2021

(30) Foreign Application Priority Data
Dec. 24, 2018 (CN) 201811577354.7

(51) Int. Cl. B41J 2/045; B41J 3/407

(52) U.S. Cl. CPC B41J 2/04573; B41J 3/4073; B41J 2/04586

(57) ABSTRACT

The present invention provides a printing method for inkjet printers, wherein with the control system, the object to be printed continuously rotates, carriage traverses in the Y axis direction and print heads in carriage jet ink on the target printing position. Specifically, firstly get the diameter (or radius) of the object to be printed. Secondly, based on the diameter (or radius) acquired, FPGA processor calculates a frequency division factor N and a multiplication factor M independently or with the assistance of an external processor. Thirdly, with the said factor N and factor M, FPGA processor converts the encoder resolution (which is an inherent value of the encoder resolution) to calculate the actual image printing resolution. Fourthly, signals which contain the converted resolution are sent to the printing control system to print images. The printing method of the present invention can ensure excellent printing quality and uniform resolution for objects with different diameter (or radius).

### CROSS-REFERENCES TO RELATED APPLICATIONS

This application is a national stage application of International Application No. PCT/CN2019/122325, filed Dec. 2, 2019, entitled “A printing method for inkjet printers”.

### FIELD OF THE INVENTION

The present invention provides a printing method for inkjet printers, which specifically applies to printing on objects in the shape of cylinder or cone and print zones that are of cylindrical or conic shape.

### BACKGROUND OF THE INVENTION

For existing techniques, the simplest method for printing on curved surfaces is to print on planar media and then combine the planar media with the curved surfaces. This method takes lots of time and effort, and can't guarantee the printing effects. For example, Chinese patent No. CN94115805.5 introduces a thermal transfer method for printing on curved surfaces. It takes silk paper as the transfer media and prints images on the media with high-temperature sublimation dye method. First, pre-treat the objects, including cleaning the surface of the object, applying primer to it and thermo-hardening the primer, and applying induction resin to it and hardening the resin. Second, apply a layer of induction adhesive agent to the transfer media, which can dissolve with and adhere to the resin on the object to be printed. Thirdly, paste the transfer media to the surface of the object. With the high-temperature sublimation, images can vividly be printed on the curved surfaces without the pressing of moulds. Images printed with this method are durable and hard to peel off.

With the developing of inkjet printing methods, methods of direct printing on curved surfaces occur. In the Chinese patent No. 200510045534.7, it presents a printing apparatus that can print on candles. The printing apparatus includes a printing module, which consists of the module bracket, print heads, and two parallel rotating shafts. Print heads are installed on the module bracket and can traverse along the module bracket. At least one of the rotating shafts is connected with the driving device, and the driving device communicates with the printing module with circuit boards. Candles are put on the parallel shafts for printing. Because candles are not pressed during rotation, slippage may occur to candles during rotation. Besides, inks are jetted to the surface of candles while the print heads are moving along the brackets and candles are rotating with the shafts. Its printing speed and printing efficiency are low. In addition, no measures are taken to ensure uniform printing resolution if candles with different diameters are used to print on.

In the Unites States patent No. US20100295885A1, it provides an inkjet apparatus for printing on partially cylindrical objects. The apparatus comprises one or more print heads positioned above the cylindrical surface. While printing, print heads keep still, the object to be printed rotates and moves forward along the central axis. Though the printing speed is high, the structure of the apparatus is complicated and the printing cost is high.

In the Japan patent JPH08207265A, a printing apparatus is supplied to print high quality images on the surfaces of cylindrical objects with different diameters. The apparatus consists of a printing module where print heads are installed to jet inks to the surfaces of cylindrical objects. One adjusting device is installed on the apparatus to adjust the distance between the cylindrical surface of the object and print heads to a pre-set value. The adjusting device consists of a pair of rotating shafts to support the object and drive the object to rotate around its central axis. One motor is used to drive at least one of the shafts rotating. The apparatus also includes a double-shaft driving unit, a lift unit and a pressing unit. The printing module driven by lead screw moves along the central axis of the object to be printed and jets ink to the object. For this apparatus, both the printing speed and the printing efficiency are low.

When printing on cylindrical objects with different diameters, the color of the output images may be uneven if the printing data has not been well processed. Due to the accumulation of errors in each circle of the object's rotation, the output image may get deformed or the beginning and the end of the output image can't be well spliced. Besides, carriage should moves at an ideal speed that is influenced by factors such as the fire frequency, the diameter of the objects to print on, the image resolution and the pulse number when the object to be printed rotates for 360°. If the actual moving speed of the carriage is greatly different from the ideal speed, the quality of the output images are bad or even the target images can't be printed out.

### SUMMARY OF THE INVENTION

Against the above-mentioned problems of the existing techniques, the present invention provides a printing method which enables to print qualified images with uniform resolution (such as 600, 900, 1200 Dots Per Inch) on cylindrical and conic objects or print zones.

The present inventions provides a printing method for inkjet printers, wherein with the printing control system, the object to be printed continuously rotates, carriage traverses in the Y axis (the first axis direction) and print heads on the carriage jet ink on the target printing position. The features of the invention are that with the frequency division and multiplication processing method and the error modification algorithm, printers can output images with uniform resolution when printing on objects with different diameter (or radius). The details are as follows.

Firstly, get the diameter (or radius) of objects to print on. Secondly, based on the diameter (or radius) of objects, FPGA (Field programmable Gate Array) processor calculates the frequency division factor N and the multiplication factor M independently or with the assistance of an external processor.

Thirdly, by using the said frequency division factor N and frequency multiplication factor M, during printing, FPGA processor takes encoder's fix resolution signal converts to an actual print resolution print head fire signal;

Fourthly, the converted print resolution fire signal is sent to the print head control system to jet ink. The calculating method of the said factors N and M in the second step for the printing method claimed can be got with the equations:

M=INT (Max_MN/div), N=INT(Mxdiv), div=D3/D2, and D3=n×D1×25.4/(2πR), in which INT means taking the integer of the result value got in parentheses, D3 stands for the equivalent resolution on the circumference of objects to print on, D1 stands for the encoder resolution, n stands for the subdivision multiple of the encoder resolution, R stands for the radius of the object to be printed, D2 stands for the printing resolution required by the image, and Max MN stands for the maximum value in the range for the frequency division factor N.

In the printing method for inkjet printers claimed, the external processor refers to the ARM processor program code which assists to calculate the frequency division factor N and the multiplication factor M. In the printing method for inkjet printers claimed, the values for the frequency division factor N and multiplication factor M can also be obtained with method of exhaustion.

In the printing method for inkjet printers claimed, error modification is adopted while the encoder resolution is converted to the actual image printing resolution. Specifically, the value for original ink drops per circle is processed with frequency multiplication and then divided with Shift Number. The frequency division factor is modified to N+1. Then the value for original ink drops per 360 degrees rotation circle is divided with (Print Cycle-Shift Number), and the frequency division factor is N. Shift Number stands for the modified ink drops per circle, and Print Cycle stands for the ink drops per circle.

In the printing method for inkjet printers claimed, Print Cycle can be derived with the equation Print Cycle=INT(n×D1×M/N), in which INT means taking the integer of the result value got in the parentheses, n stands for the subdivision multiple of the encoder resolution and D1 stands for encoder resolution. In the printing method for inkjet printers claimed, Shift Number can be derived with the equation Shift Number=n×D1×M % N, in which n stands for the subdivision multiple of the encoder resolution, D1 stands for the encoder resolution, and % stands for the modulo operation giving the remainder of dividing the value of n×D1×M by N.

In the printing method for inkjet printers claimed, carriage moves in the Y axis (the first axis direction) during printing with a modified speed in the fourth step. First calculate the theoretical moving speed of carriage. And then adjust the actual moving speed of carriage to make it approach to the theoretical value to the largest extent until the actual moving speed of carriage is within the tolerance range.

In the printing method for inkjet printers claimed, the objects to print on can be in the shape of cylinder or cone, or the print zones are of the cylindrical or conic shape.

The advantages of the printing method claimed in this invention are as follows.

1. With the algorithm adopted, optimal values for the frequency division factor N and multiplication factor M can be calculated, which can ensure that inkjet printers can print images with the same color and uniform resolution when printing on objects with different diameters.

2. Except the frequency division and multiplication processing, rounding error compensation modifications are also applied to modify the ink drops per circle to ensure the rounding errors does not propagate and accumulate. This can ensure that ink drops are evenly distributed without error accumulation.

3. When the object to be printed rotates around its central axis at a constant speed, carriage moves in the Y axis (the first axis direction) at an ideal speed that has been adjusted (considering the rounding errors on the rotation) to the tolerance range, which can ensure the printing quality.

### BRIEF DESCRIPTION OF THE DRAWINGS

FIG. 1 shows the three-dimensional illustration of the inkjet printing apparatus in an embodiment of the invention.

FIG. 2 shows the internal structure of the first embodiment shown in FIG. 1 after hiding the external covers.

FIG. 3 shows the three-dimensional illustration of the inkjet printing apparatus in another embodiment of the invention.

FIG. 4 shows the top view of the head plate with the print heads and the object to be printed in one of the embodiments.

FIG. 5 shows the printing work flow of the invention.

FIG. 6 is the figure table showing related parameters and calculated results when the radius of the object to be printed is in the range of 20 mm-30 mm.

FIG. 7 is the figure table showing related parameters and calculated results when the radius of the object to be printed is in the range of 30.5 mm-45 mm.

FIG. 8 is the figure table showing related parameters and calculated results when the radius of the object to be printed is in the range of 45.5 mm-60 mm.

In the Figs., the serial No. respectively stands for carriage 1, linear beam 2, heads maintenance unit 3, rotating jig fixture unit 4 for the object to be printed, curing lamp window unit 5, printer base frame 7, external covers 8, LCD control panel 9, cable carrier of carriage 10, object to be printed 0, linear beam 02, turntable unit 04 for objects to be printed, print head 11, head plate 13, supporting beam 101, the first print head 11a, the second print head 11b, the third print head 11c and the fourth print head 11d.

### DETAILED DESCRIPTION OF THE EMBODIMENT

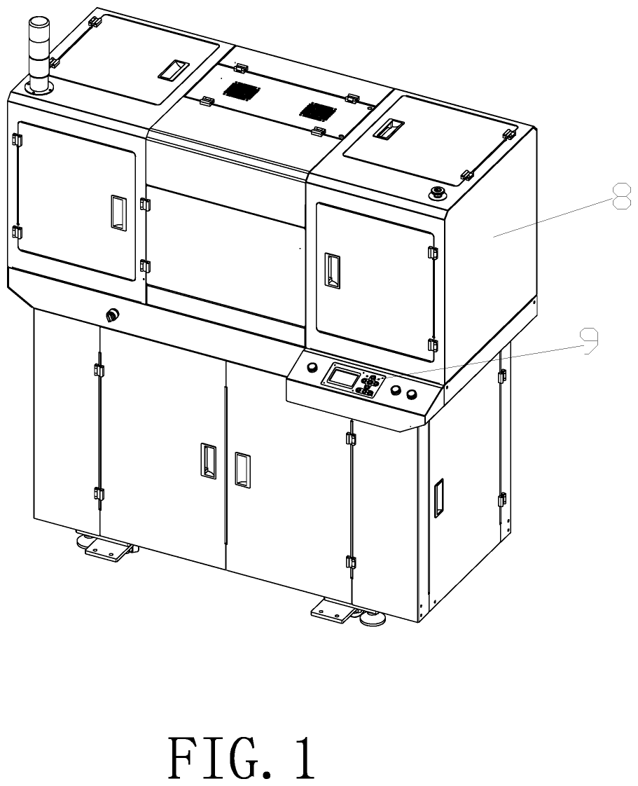

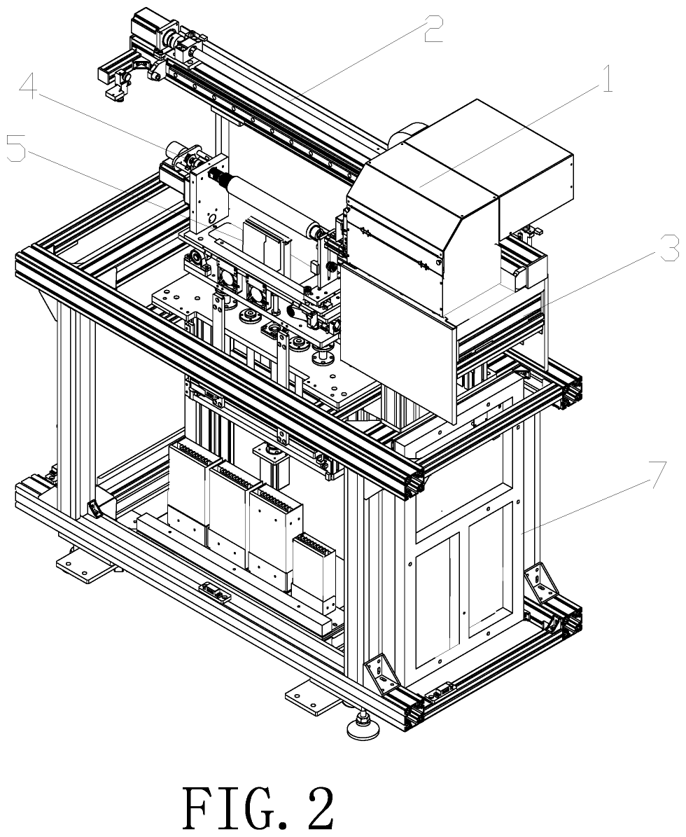

Following are detailed descriptions of the invention with the said Figs. and embodiments. As shown by FIG. 1 and FIG. 2, the inkjet printing apparatus in the first embodiment includes carriage 1, linear beam 2, head maintenance unit 3, rotating jig fixture unit 4 for the object to be printed , curing unit 5, printer base frame 7 and external covers 8. Carriage 1 is installed on the linear beam 2 and traverses along linear beam 2 in the Y axis (the first axis direction). Print heads are installed in carriage's head plate with the print heads' columns of nozzles orientated linearly parallel and above the center rotation axis of the rotating jig fixture. While carriage 1 continuously moves along the Y axis direction (the first axis direction), print heads jet ink to print on the object's cylindrical or conical surface. Ink tanks and negative pressure control system are also installed to carriage 1. Head maintenance unit 3 is installed under the linear beam 2 and the initial position of carriage 1, and consists of wiping blades and head caps (not shown in the figure). Wiping blades are used to wipe clean print heads' nozzle plates on carriage 1, and head caps are used to protect print heads from drying up the nozzles clogging the print head. Rotating jig fixture unit 4 for loading and rotating object to be printed is installed below the carriage 1 and the linear beam 2. The rotation axis is parallel and below the carriage's head nozzles. The rotating jig fixture can also moves vertically up and down for accommodate and adjust object with different diameter so that the objects top surface highest point is leveled and linearly parallel to the head nozzles. This rotating jig fixture can also adjust the tilt angle for conical objects so that the top conical surface is parallel and leveled to the print head .The rotating jig fixture unit is to hold objects to be printed and control the rotation motion of the objects to be printed. For the first embodiment, objects to print on refer to cylindrical or conical objects. Load and fix the object to be printed to the rotating jig fixture unit 4, and adjust the distance between the object's top surface and the nozzles of print heads to an optimal z gap height distance. The object to be printed continuously rotates around its central axis during printing. Curing lamp window unit 5 is installed under the object to be printed to cure ink jetted on the object. In addition, the curing width range of curing lamp window unit 5 can be adjusted according to the length of the object to be printed. Printer base frame 7 supports the above-mentioned parts. External covers 8 are for presenting attractive appearance. LCD control panel 9 helps to control printing or maintenance operations. When printing Conical surface objects (such as a drinking cup), the top surface of the conical object's tilt angle needs to be adjusted on the rotating jig fixture unit 4 until conical object's top surface is horizontally leveled (parallel) to the print head on the carriage which moves along the Y axis during printing where print image data for conical surface can also be processed with corresponding software algorithm. The object's surface either cylindrical or conical shape objects or print zones should not be considered a limiting factor for the present invention.

The height of the print object surface to the print head nozzles can be adjusted vertically by the Z axis movement of the rotating jig or by adjusting the carriage's Z height. The adjusting method should not be considered as a limited factor for the present invention.

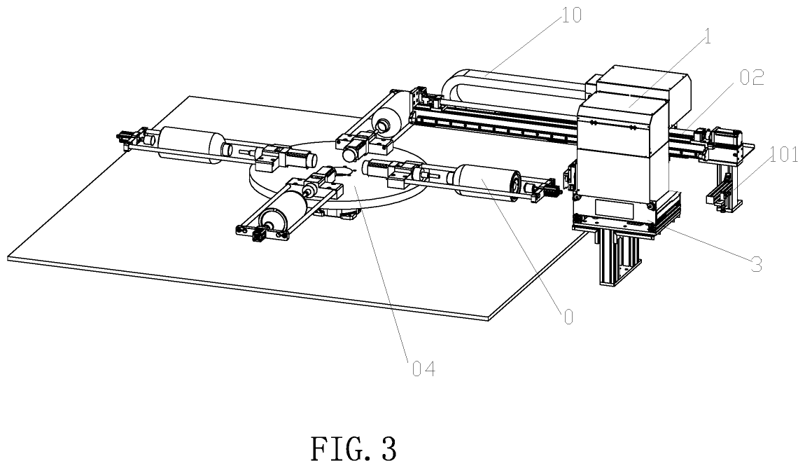

FIG. 3 is the illustration of a second embodiment of the invention. The second embodiment includes carriage 1, linear beam 02, print heads maintenance unit 3, turntable unit 04 for objects to be printed, and support 101. Carriage 1 is installed to linear beam 2, and connects with cable carrier 10. Carriage 1 with cable carrier 10 can traverse along linear beam 2 in the Y axis direction. Ink tanks and negative pressure control system are also installed to carriage 1. Print heads maintenance unit 3 is installed at one side of linear beam 2 and under the initial position of carriage 1. The above-mentioned composing parts of the second embodiment are basically similar to those of the first embodiment. Comparing with the first embodiment, the second embodiment has a turntable unit 04. The turntable unit 04 is under the linear beam 02 and at the left side of the initial position of carriage 1. The turntable 04 has four rotation jig arm positions, which can hold as much as four objects to print on. During printing, the object to be printed at one station is index turned to the position under carriage 1 and the rotating jig fixture on the index arm rotates around its main central axis, and carriage 1 travels in the Y axis direction and print heads in the carriage jet ink to the said object. At the same time while printing, operations such as loading object to be printed on the jig, curing the object after being printed on and unloading the object after being final cured can be done at the remaining stations. Support 101 is installed at the right bottom side of the linear beam 2 and to support linear beam 2.

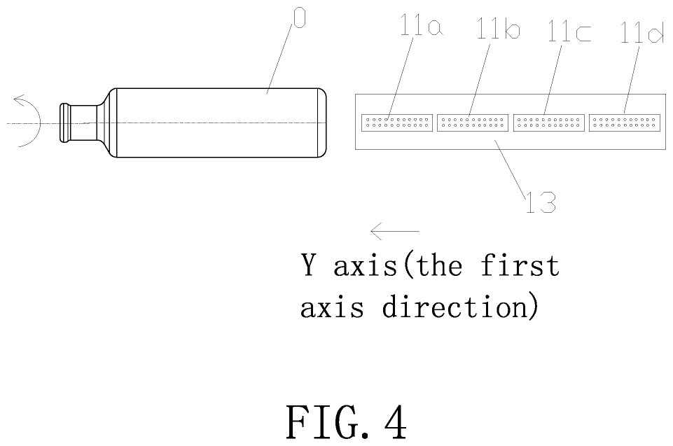

FIG. 4 is the top view of the head plate 13 with print heads mounted showing the nozzle columns which are parallel and above the object center rotation axis and the object to be printed in one embodiment. The bottom of head plate 13 is parallel with the Y axis (the first axis direction). Four print heads, respectively 11a, 11b, 11c and 11d, are installed to head plate 13 in series along the Y axis (the first axis direction). Each print head can jet one or two kinds of colors according to requirements. In the embodiment, print head 11a jets white ink or varnish. Print head 11b jets black ink K and cyan ink C. Print head 11c jets magenta ink M and yellow ink Y. Print head 11d jets vanish or does not jet ink. Print heads moves in the Y axis (the first axis direction) to the position above the print zone of the object 0 and start to jet ink synchronized the jet firing using the FPGA processor computed jet/fire signal.

The quantity of print heads and ink colors of each print head, the arrangement of ink colors and the type of inks should not be considered limited factors for the invention. Head plate 13 can also hold three or other quantity of print heads. Besides, each print head can print one kind of ink color or two kinds of ink colors.

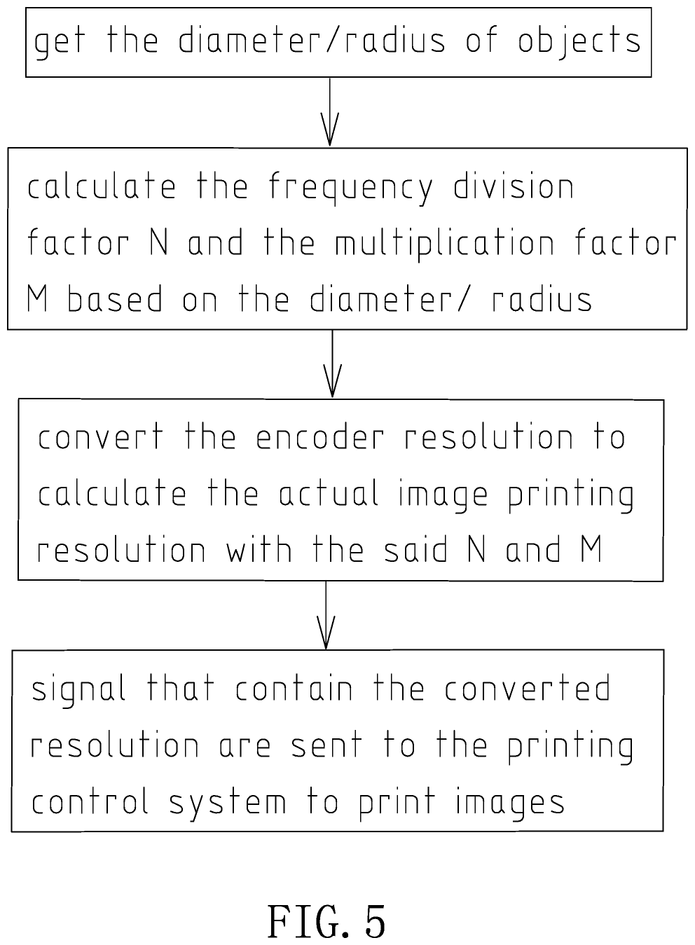

Following introduces the data processing method of the embodiments according to the work flow in FIG. 5. Firstly, get the diameter (or radius) of the object to be printed. The diameter (or radius) can be manually entered to the software or auto measured by the sensor. Secondly, according to the said diameter (or radius), the software calculates the frequency division factor N and the multiplication factor M. With specific algorithm, the factors N and M are approximately equal to their theoretical values to the largest extent. Thirdly, by using the said frequency division factor N and frequency multiplication factor M, during printing, FPGA processor will take encoder's fix resolution signal converts to an actual print resolution print head fire signal. Because N and M are approximate values, error modification is adopted while converting the resolution. Fourthly, the converted print resolution fire signal is sent to the print head control system to jet ink. During printing, the speed of carriage's motion in the first direction is rectified to ensure the printing quality.

The algorithm of factors N and M for objects with different diameters (or radius) is as follows. One encoder with fixed resolution is pre-installed on a rotating shaft which can rotate with the object to be printed. The encoder's fix resolution is defined as D1. Then subdivide D1 into n times and the resolution can be shown as n×D1. The target printing resolution required by the image is defined as D2, and the equivalent resolution around the circumference of the object to be printed is defined as D3. Firstly, get the diameter (or radius) of the object to be printed to obtain radius R. Secondly, with the radius, calculate the equivalent resolution D3 with the equation D3=n×D1×25.4/(2πR).Thirdly, get the conversion ratio div with the equation div=D3/D2=n×D1×25.4/(2πR)/D2. Fourthly, taking N to stand for the frequency division factor and M to stand for the multiplication factor, N and M meet the equation div=N/M. Take the maximum value for N as Max_MN. To decrease the error to the largest extent, the values for N and M are derived from the equations: M=INT (Max_MN/div) and N=INT (M×div), in which INT operation stands for taking the integer of the value got in the parenthesis. To get proper values for N and M, FPGA processor is used independently or with the assistance of ARM microprocessor program. Fifthly, with the values of N and M, convert the encoder's fix resolution signal to calculate the actual image print resolution fire signal with the equation: D3×M/N, which can further expressed as [n×D1×25.4/(2πR)]×M/N. Sixthly, the fire signals that contain the converted resolution are sent to the printing control system to print the image. This signal correction algorithm can ensure that when printing on objects with different diameter, printer using a fix count rotary encoder can output images with uniform resolution and even colors.

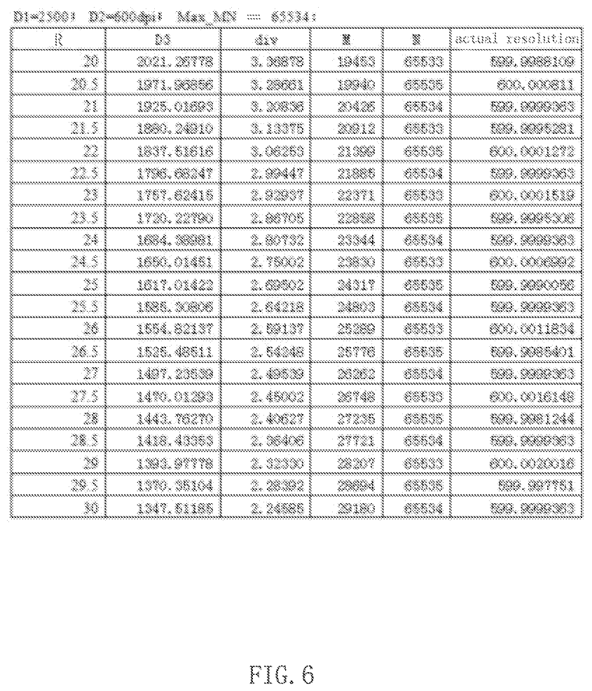

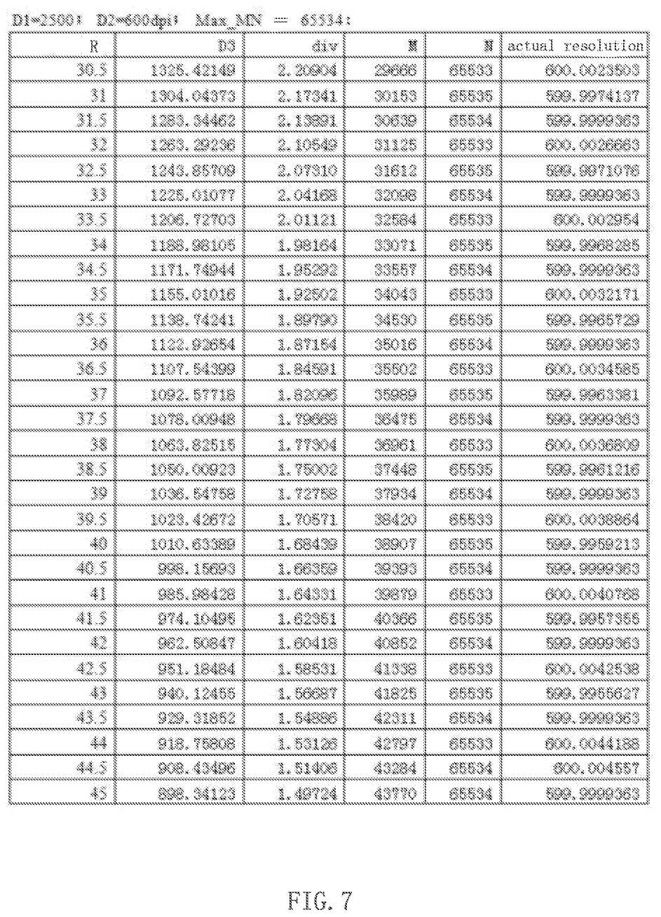

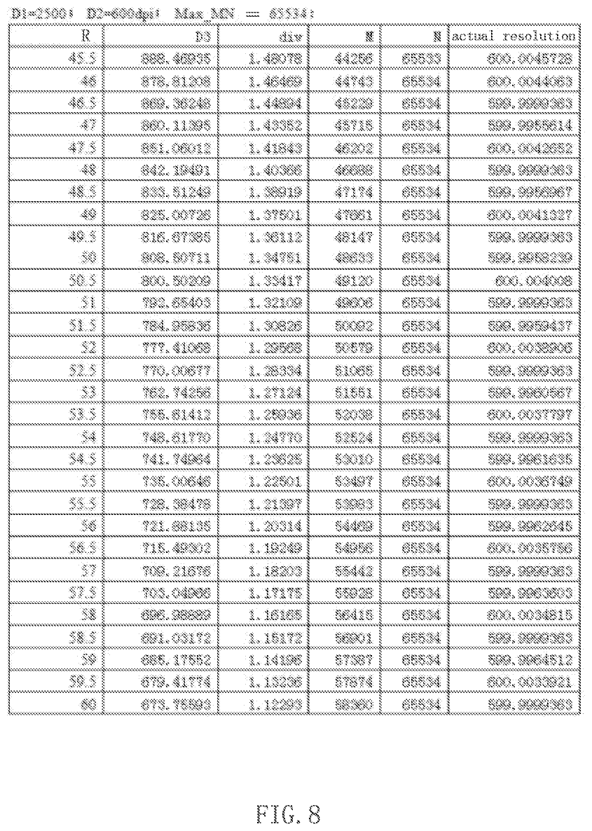

In the said embodiments, supposing D1=2500, n=4, R=20 mm, and D2=600 dpi, calculate and get the values for D3 and div with the equations: D3=2500×4×25.4/(2π×20)≈2021.26778 dpi, and div=D3/D2=2021.26778/600≈3.36878. Presetting the Max_MN to 65534, calculate and get the values for M and N with the equation: M=INT (Max_MN/div)=INT (65534/3.36878)=19453, and N=INT (Mxdiv)=INT(19453×3.36878)=65533. With the values for factors N and M that minimize the errors to the largest extent, encoder signals with the corrected signal are sent to the printing module to print. With the said values, the theoretical value for the actual image printing resolution can be calculated with the equation: D3×M/N=2500×4×25.4/(2π×20)×19453/65533≈599.9988109, which is equivalent to the image resolution 600 dpi where the small decimal difference error cannot be seen visually in actual prints. When printing on objects with different radiuses, the values for factors N and M will be re-calculated. Therefore, this method is suitable for printing on cylindrical or conical objects with different radiuses. Normally the radius of the object to be printed is within the range of 20 mm-60 mm. As shown in the FIG. 6 to FIG. 8, it can be found that the actual image printing resolution got with the algorithm changes in the range 599.995614 to 600.0045728, and the tolerance value is 0.0090114. Comparing with the image resolution 600 dpi, good print quality can be achieved with the actual printing resolution.

In the said algorithm, the value for Max_MN is preset to 65534. It is found that, if the value for Max_MN is preset to 254, good print quality can also be achieved with the actual printing resolution. The value for Max_MN should not be a limited factor for the invention, as along as the value can ensure to output images with resolution that is closely approximate to the resolution required by the image.

Besides of the said algorithm, the method of exhaustion can also be used to get the optimal values for factors N and M. Specifically, supposing the value for M is 1 and the value for N gradually changes from 1 to Max_MN, respectively calculate the ratio of N/M. Then, supposing the value for M is 2 and the value for N gradually changes from 1 to Max_MN, calculate each ratio of N/M again. Follow this order and calculate the ratios of N/M until M gets to the value Max_MN. Compare all ratios of N/M and find the optimal ratio that is mostly equivalent to the value of div. The values of N and M that are used to get the optimal ratio will be taken as the final values of N and M.

The algorithms for getting the values for factors N and M should not be limited factors of the invention. As long as the ratio of N/M is closely equivalent to the value of div and the actual image printing resolution is within the acceptable range, the algorithm used to get the values of N and M can be applied.

In the process of frequency division and multiplication, because of the radius differences of the objects to print on, the number of ink drops for per circle may not be integer, which will cause error accumulation. If errors accumulate at the end of each circle instead of distributing around the circle, white gap or overlap may occur at the junction of the beginning and the end of the image (360 degrees image print wrap). To avoid the problems and ensure uniform resolution, error modification is used while converting the encoder resolution to the actual image printing resolution. Specifically, supposing the original ink drops per circle for the encoder's resolution signal is n×D1, and the ink drops per circle for the image resolution is n×D1×M/N and taking its integral value with the equation Print Cycle=INT(n×D1×M/N). Then the software will RIP the image according to the value of Print Cycle. Because the result of n×D1×M/N may be a number with remainder, the error caused by the remainder should be modified in the full circle of one rotation. The modified number of each circle is defined as Shift Number and can be calculated with the equation: Shift Number=n×D1×M % N, in which % is the modulo operation which returns the remainder of the division. Specifically, the value for original ink drops per circle is processed with frequency multiplication and then divided with Shift Number. The frequency division factor is modified to N+1. Then the value for original ink drops per circle is divided with (Print Cycle-Shift Number), and the frequency division factor is N. It is to be noted that the value of Shift Number is smaller than that of Print Cycle by default.

The said error modification algorithm can be expressed with the equation: n×D1×M=(Print Cycle-Shift Number)×N+Shift Number×(N+1). With the said algorithm, the remainder Shift Number can be evenly distributed among the ink drops per circle Print Circle to avoid error accumulation. The said algorithm helps to keep the uniform resolution to the largest extent and smooth junction at the beginning and the end of the image.

During the printing, the object to be printed rotates with a constant speed Vx which is decided by the fire frequency, and carriage moves in the first direction with a modified speed. The modified speed of carriage ensures that inks drop on the correct position of the said object after being rotated. Specifically, based on the fire frequency, the diameter of the object to be printed, the image resolution and the total pulse number in a circle, the software first calculates the theoretical speed of carriage (Vy) and carriage moves with the theoretical speed. Then by comparing the actual moving distance and the theoretical moving distance of carriage, calculate the error and modify the moving speed of carriage. Then carriage moves with the modified speed. Repeating the said process to adjust the moving speed of carriage until the error is within the tolerance range.

It is to be noted that any variant or modification that is based on the described embodiments does not deviate from the spirit and scope of the present invention.

What is claimed is:

1. This invention provides a printing method for inkjet printers, wherein with the control system, the object to be printed continuously rotates, carriage traverses in the Y axis (the first axis direction) and print heads on the carriage jetting ink on the target printing position; the features of the invention are that with the frequency division factor and multiplication factor and the error modification algorithm, printers can output images with uniform resolution when printing on objects with different diameter (or radius); the printing method consists of the following steps:
Firstly, the printing control system gets the diameter (or radius) of objects to be printed;
Secondly, based on the diameter (or radius) of objects, FPGA processor calculates a frequency division factor N and a frequency multiplication factor M independently or with the assistance of external processor;
Thirdly, by using the said frequency division factor N and frequency multiplication factor M, during printing, FPGA processor takes encoder's fix resolution signal converts to an actual print resolution print head fire signal;
Fourthly, the converted print resolution fire signal is sent to the print head control system to jet ink.

2. The printing method as claimed in claim 1, wherein the frequency division factor N and the multiplication factor M in the second step are calculated with the following algorithm:
The multiplication factor M=INT (Max_MN/div), and the division factor N=INT(M×div), in which INT means to take the integer of the result value in parentheses; the converted ratio div=D3/D2, in which D3 stands for the equivalent resolution on the circumference of the object to be printed; D3=n×D1×25.4/(2πR), in which D1 stands for the encoder resolution, n stands for the subdivision multiple of the encoder resolution, R stands for the radius of the object to be printed, D2 stands for the resolution required by the image to print, and Max MN stands for the maximum value in the range for the frequency division factor N.

3. The printing method as claimed in claim 1, wherein the said external processor in the second step refers to the ARM processor program code, which can assist to calculate the frequency division factor N and multiplication factor M.

4. The printing method as claimed in claim 1, wherein the values for the frequency division factor N and multiplication factor M in the second step also can be obtained with the method of exhaustion.

5. The printing method as claimed in claim 1, wherein error modification is adopted while the encoder resolution is converted to calculate the actual image printing resolution in the third step; the value for original ink drops per circle (one circle means that the object to be printed rotates for 360 degree) is processed with frequency multiplication and then divided with Shift Number; the frequency division factor is modified to N+1; then the value for original ink drops per 360 degree rotation circle is divided with (Print Cycle-Shift Number), and the frequency division factor is N; Shift Number stands for the modified ink drops per circle, and Print Cycle stands for the ink drops per circle.

6. The printing method as claimed in claim 5, wherein the ink drops per circle Print Cycle=INT(n×D1×M/N), in which INT stands for taking the integer of the result value in the parentheses, n stands for the subdivision multiple of the encoder resolution and D1 stands for the encoder resolution.

7. The printing method as claimed in claim 5, wherein the modified ink drops per circle Shift Number=n×D1×M % N, in which n stands for the subdivision multiple of the encoder resolution, D1 stands for the encoder resolution, and % stands for the modulo operation which returns the remainder of n×D1×M by N.

8. The printing method as claimed in claim 1, wherein carriage moves in the first direction during printing with a modified speed; first calculate the theoretical moving speed of carriage, and then adjust the actual moving speed of carriage to make it approach to the theoretical value to the largest extent until the actual moving speed of carriage is within the tolerance range.

9. The printing method as claimed in claim 1, wherein objects to print on are in the shape of cylinder or cone, or print zones are of cylindrical or conic shape.
